(19) United States
(12) Patent Application Publication
(10) Pub. No.: US 2018/0203215 A1
(43) Pub. Date: Jul. 19, 2018

(54) Optical Magnification System

(71) Applicants: Sintai Optical (Shenzhen) Co., Ltd., ShenZhen City (CN); Asia Optical Co., Inc., Taichung (TW)

(72) Inventor: Chia-Kan Chang, Taichung (TW)

(21) Appl. No.: 15/791,527

(22) Filed: Oct. 24, 2017

(30) Foreign Application Priority Data
Jan. 19, 2017 (CN) 201710043495.X

(51) Int. Cl. G02B 15/16

(52) U.S. Cl. CPC G02B 15/161

(57) ABSTRACT

An optical magnification system includes a lens barrel, a lens seat, a bush and a fixing element. The lens barrel has a slot. The lens seat includes a seat body and a sliding portion, wherein the seat body is movably disposed within the lens barrel, and the sliding portion is disposed on the seat body, extends into the slot and is configured to slide within the slot. The bush is movably disposed on the lens barrel. The fixing element extends through the bush and the sliding portion and is fixed to the seat body. The lens seat is configured to move relative to the lens barrel and along the slot via the sliding portion. The lens seat and the bush are respectively forced against the inner circumferential surfaces and the outer circumferential surfaces of the lens barrel by the fixing element.

### BACKGROUND OF THE INVENTION

### Field of the Invention

The invention relates to an optical magnification system, and more particularly to an optical magnification system with the directional stability of a lens seat improved.

### Description of the Related Art

A conventional sight is generally provided with an optical magnification system 1 which, as shown in FIGS. 1-3, includes an outer lens barrel 20, an inner lens barrel 10, a first lens seat 30, a second lens seat 40, a first screw 15, a second screw 25, a first bush 35 and a second bush 45. The outer lens barrel 20 is rotatably disposed around the inner lens barrel 10 and has a first curved slot 21 and a second curved slot 22 respectively formed thereon. The inner lens barrel 10 has a straight slot 11 formed thereon and the straight slot extends parallel to an axis of the inner lens barrel 10. A first lens unit (not shown) and a second lens unit (not shown) are respectively fixed within the first lens seat 30 and the second lens seat 40. The first lens seat 30 and the second lens seat 40 are movably disposed within the inner lens barrel 10. The first screw 15 is penetrated through the first bush 35 and threaded into the first lens seat 30 to force the first bush 35 against the first lens seat 30. The second screw 25 is penetrated through the second bush 45 and threaded into the second lens seat 40 to force the second bush 45 against the second lens seat 40. The first bush 35 is configured to slide within the first curved slot 21 and the straight slot 11, and the second bush 45 is configured to slide within the second curved slot 22 and the straight slot 11.

During operation of the optical magnification system 1, the outer lens barrel 20 is rotated to slide the first bush 35 and the second bush 45 respectively within the first curved slot 21 and the second curved slot 22. Since the first bush 35 and the second bush 45 are simultaneously slid within the straight slot 11, the first lens seat 30 and the second lens seat 40 are moved along the straight slot 11 relative to the inner lens barrel 10, thereby adjusting the magnification of the optical magnification system 1.

If a clearance between the lens seat and the inner lens barrel is undue, user's view through the lens unit may irregularly jitter relative to the reticle of the sight. To address the problem, reducing the dimensional tolerance between the lens seat and the inner lens barrel may be a solution. However, that requires higher manufacturing accuracy and therefore increases the manufacturing cost.

### BRIEF SUMMARY OF THE INVENTION

The invention provides an optical magnification system. The lens seat of the optical magnification system is constrained within the inner lens barrel to avoid uncontrolled rotation, shaking or jittering of the lens seat relative to the inner lens barrel. As a result, the lens seat can be moved stably in an axial direction of the inner lens barrel relative to the inner lens barrel.

The optical magnification system in accordance with an embodiment of the invention includes a first lens barrel, a first lens seat, a first lens unit, a first bush and a first fixing element. The first lens barrel, with a slot formed thereon, includes inner circumferential surfaces and first outer circumferential surfaces. The first lens seat includes a first seat body and a first sliding portion, wherein the first seat body is movably disposed within the first lens barrel, and the first sliding portion is disposed on the first seat body, extends into the slot and is configured to slide within the slot. The first lens unit is disposed within the first lens seat. The first bush is movably disposed on the first lens barrel. The first fixing element extends through the first bush and the first sliding portion and is fixed to the first seat body. The first lens seat is configured to move relative to the first lens barrel and along the slot via the first sliding portion. The first lens seat and the first bush are respectively forced against the inner circumferential surfaces and the first outer circumferential surfaces of the first lens barrel by the first fixing element.

In another embodiment, the first seat body and the first sliding portion are integrally formed as a continuous-unity piece.

In yet another embodiment, the first seat body includes a first recessed portion, and the first sliding portion is disposed in the first recessed portion and extends into the slot.

In another embodiment, the first seat body further includes second outer circumferential surfaces, and the first recessed portion is disposed on the second outer circumferential surfaces.

In yet another embodiment, the optical magnification system further includes a first compression ring configured to fix the first lens unit within the first lens seat.

In another embodiment, the optical magnification system further includes a second lens barrel movably disposed around the first lens barrel, wherein a first slot is formed on the second lens barrel, the first slot is a curved slot, and the first bush is configured to slide within the first slot.

In yet another embodiment, the optical magnification system further includes a second lens seat, a second lens unit, a second bush and a second fixing element. The second lens seat includes a second seat body and a second sliding portion, wherein the second seat body is movably disposed within the first lens barrel, and the second sliding portion is disposed on the second seat body, extends into the slot and is configured to slide within the slot. The second lens unit is disposed within the second lens seat. The second bush is movably disposed on the first lens barrel. The second fixing element extends through the second bush and the second sliding portion and is fixed to the second seat body. The second lens seat is configured to move relative to the first lens barrel and along the slot via the second sliding portion. The second lens seat and the second bush are respectively forced against the inner circumferential surfaces and the first outer circumferential surfaces of the first lens barrel by the second fixing element.

In another embodiment, the second seat body and the second sliding portion are integrally formed as a continuous-unity piece.

In yet another embodiment, the first seat body and the first sliding portion are integrally formed as a continuous-unity piece.

In another embodiment, the second seat body includes a second recessed portion, and the second sliding portion is disposed in the second recessed portion and extends into the slot.

In yet another embodiment, the second seat body further includes third outer circumferential surfaces, and the second recessed portion is disposed on the third outer circumferential surfaces.

In another embodiment, the optical magnification system further includes a second compression ring configured to fix the second lens unit within the second lens seat.

In yet another embodiment, the optical magnification system further includes a second lens barrel movably disposed around the first lens barrel, wherein a first slot and a second slot are respectively formed on the second lens barrel, the first slot and the second slot are curved with different curvatures, the first bush is configured to slide within the first slot, and the second bush is configured to slide within the second slot.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a prior optical magnification system;

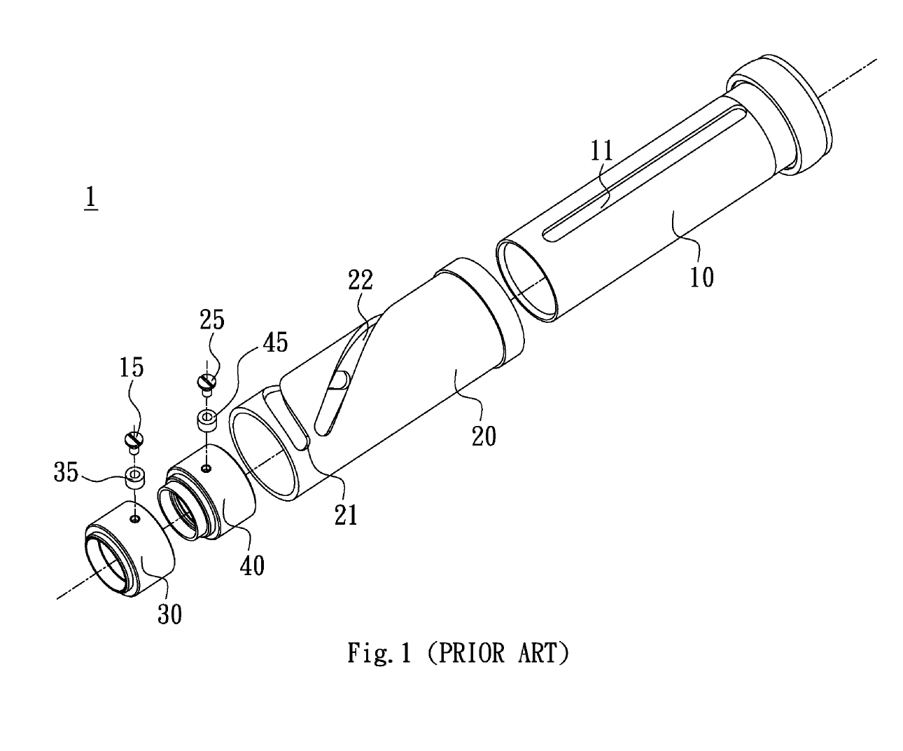

FIG. 2 is a side sectional view of a prior optical magnification system;

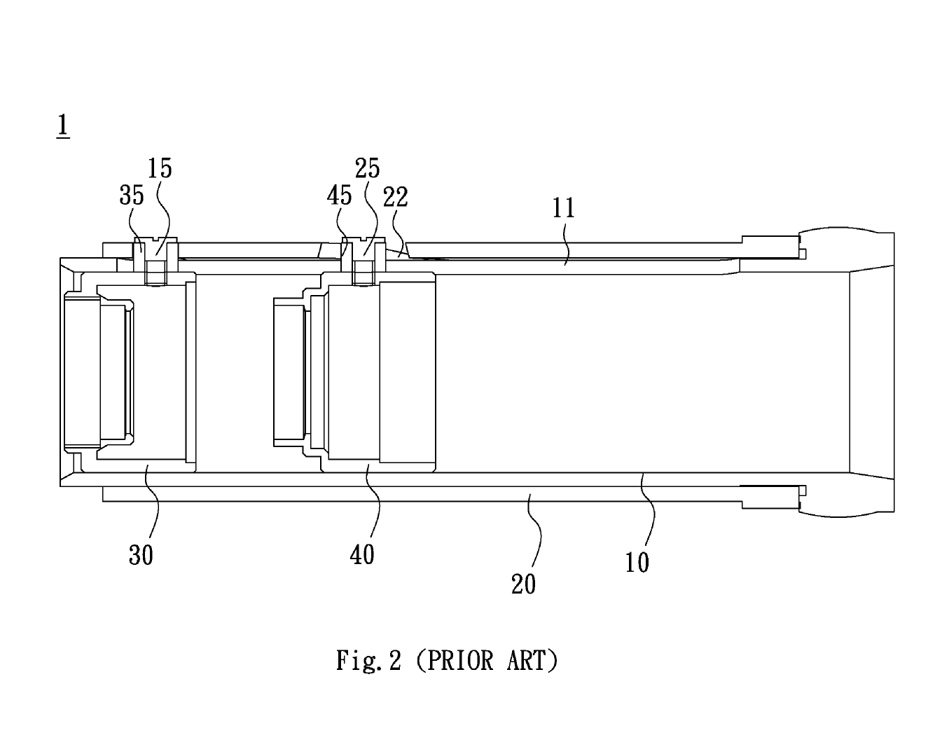

FIG. 3 is a front sectional view of a prior optical magnification system;

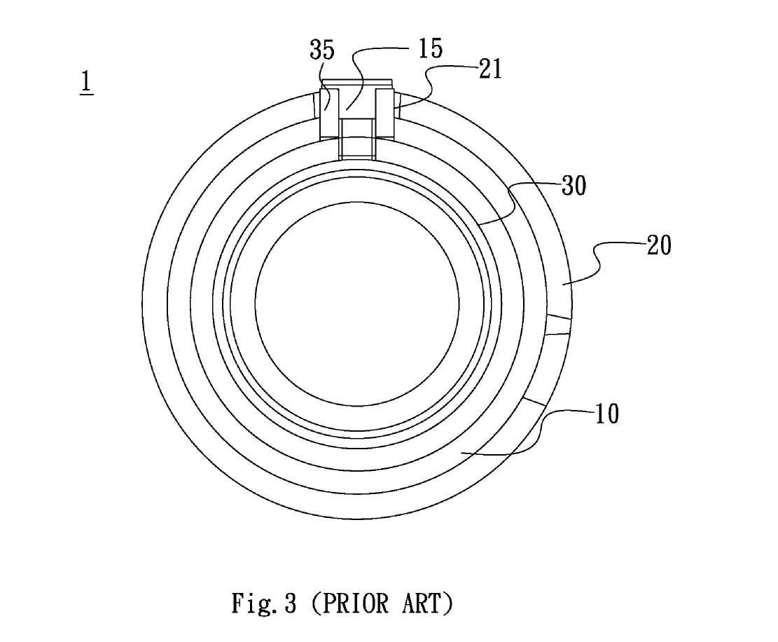

FIG. 4 is a schematic view of an optical magnification system in accordance with a first embodiment of the invention;

FIG. 5 is a side sectional view of an optical magnification system in accordance with a first embodiment of the invention;

FIG. 6 is a front sectional view of an optical magnification system in accordance with a first embodiment of the invention;

FIG. 7 is a schematic view of an optical magnification system in accordance with a second embodiment of the invention;

FIG. 8 is a side sectional view of an optical magnification system in accordance with a second embodiment of the invention;

FIG. 9 is a front sectional view of an optical magnification system in accordance with a second embodiment of the invention; and

FIG. 10 is a side sectional view of a sight provided with the optical magnification system of the first embodiment of the invention.

### DETAILED DESCRIPTION OF THE INVENTION

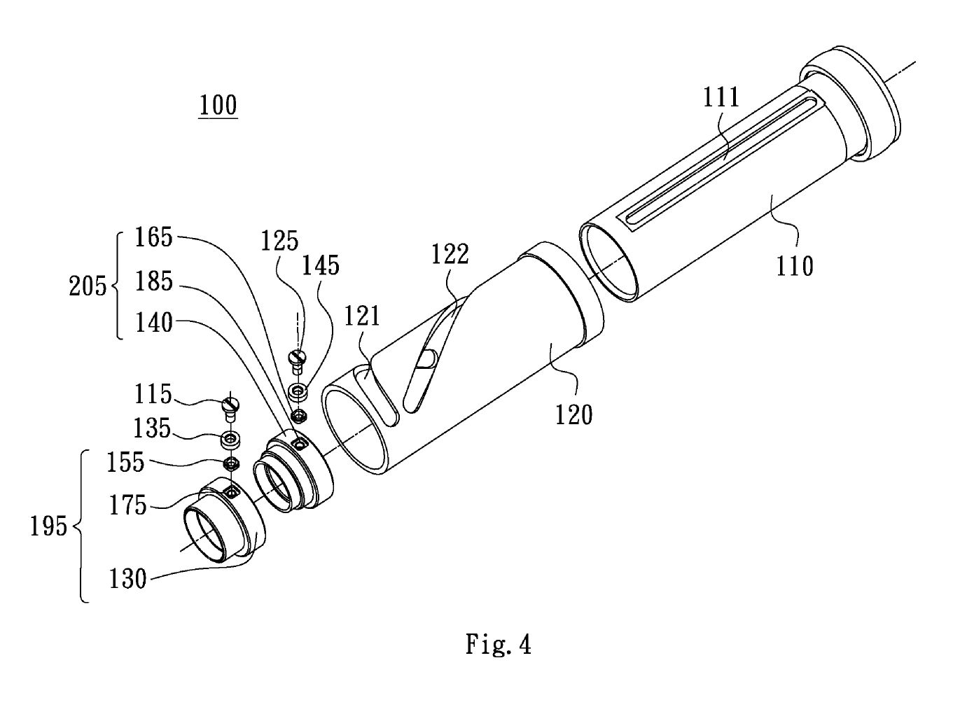

Referring to FIG. 4, an optical magnification system 100 in accordance with a first embodiment of the invention includes a first lens barrel 110, a second lens barrel 120, a first lens seat 195, a second lens seat 205, a first lens unit (not shown) and a second lens unit (not shown). The second lens barrel 120 is configured to move the first lens seat 195 and the second lens seat 205 relative to the first lens barrel 110, so as to adjust magnification of the optical magnification system 100.

As shown in FIG. 4, the second lens barrel 120 is rotatably disposed around the first lens barrel 110 and includes a first slot 121 and a second slot 122 respectively formed thereon. The first lens barrel includes a slot 111 formed thereon. In the first embodiment, the first slot 121 and the second slot 122 are curved with different curvatures. The slot 111 extends parallel to an axis of the first lens barrel 110.

The first lens unit and the second lens unit are respectively disposed within the first lens seat 195 and the second lens seat 205. In the first embodiment, the first lens unit and the second lens unit are assembled to be an erecting lens unit, and the first lens unit and the second lens unit are respectively fixed within the first lens seat 195 and the second lens seat 205 by adhesive. In another embodiment, the first lens unit is fixed within the first lens seat 195 by a first compression ring (not shown), and the second lens unit is fixed within the second lens seat 205 by a second compression ring (not shown).

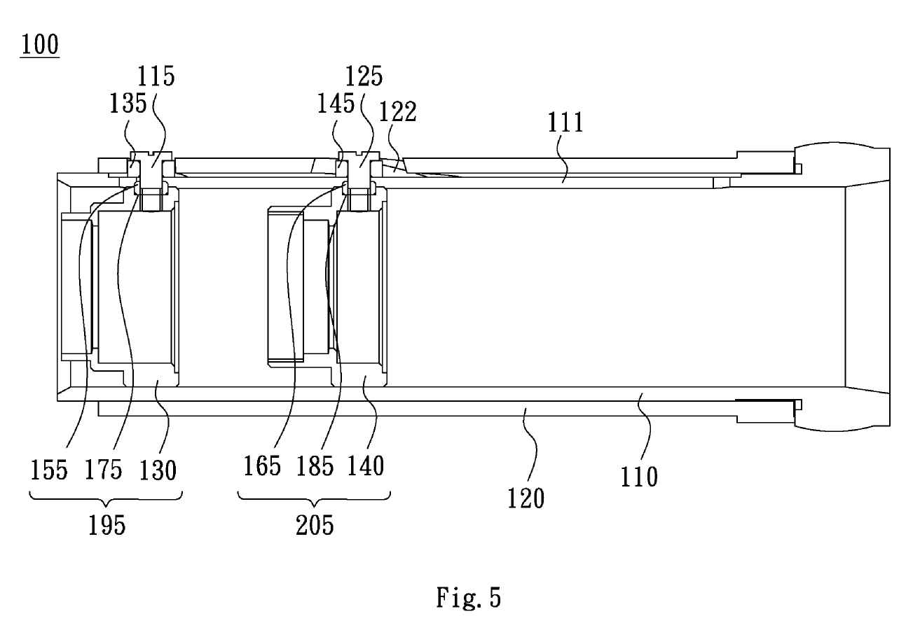

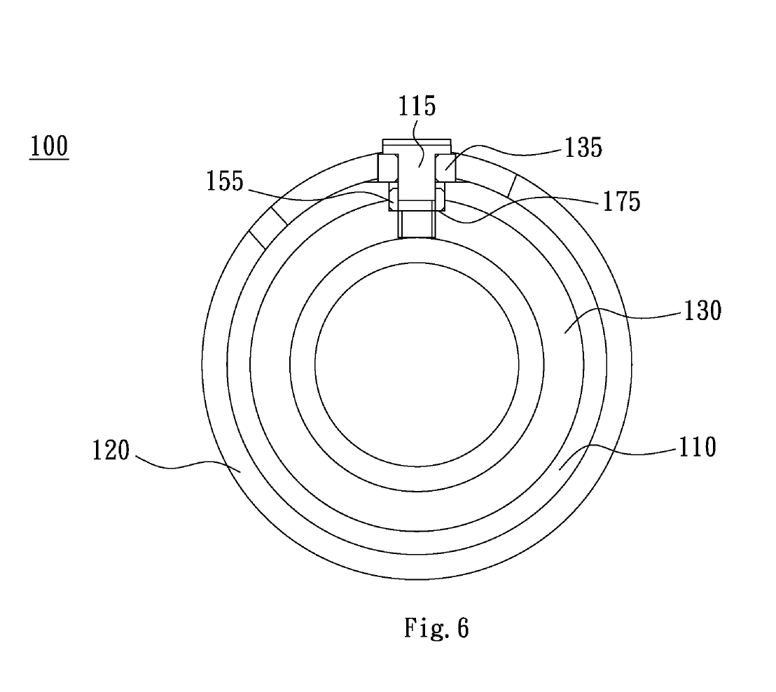

Referring to FIGS. 5 and 6, the first lens seat 195 includes a first seat body 130 and a first sliding portion 155, and the second lens seat 205 includes a second seat body 140 and a second sliding portion 165. The first seat body 130 and the second seat body 140 are movably disposed within the first lens barrel 110. The first seat body 130 includes a first recessed portion 175 and second outer circumferential surfaces, and the second seat body 140 includes a second recessed portion 185 and third outer circumferential surfaces. The first recessed portion 175 is disposed on the second outer circumferential surfaces, and the second recessed portion 185 is disposed on the third outer circumferential surfaces. The first sliding portion 155 is disposed in the first recessed portion 175 and extends into the slot 111, and the second sliding portion 165 is disposed in the second recessed portion 185 and extends into the slot 111. That is, the first sliding portion 155 and the second sliding portion 165 are able to slide within the slot 111. Therefore, the first lens seat 195 is configured to move along the slot 111 relative to the first lens barrel 110 by way of the first sliding portion 155 and the first recessed portion 175, and the second lens seat 205 is configured to move along the slot 111 and relative to the first lens barrel 110 by way of the second sliding portion 165 and the second recessed portion 185. In such arrangement, the first lens seat 195 and the second lens seat 205 are constrained from rotating relative to the first lens barrel 110.

The optical magnification system 100 further includes a first bush 135, a second bush 145, a first fixing element 115 and a second fixing element 125. The first bush 135 and the second bush 145 are movably disposed on first outer circumferential surfaces of the first lens barrel 110, and more particularly on the first outer circumferential surfaces having the slot 111. The first fixing element 115 extends through the first bush 135 and the first sliding portion 155 and is threaded into the first seat body 130, so that the first lens seat 195 and the first bush 135 are respectively forced against inner circumferential surfaces and first outer circumferential surfaces of the first lens barrel 110. Similarly, the second fixing element 125 extends through the second bush 145 and the second sliding portion 165 and is threaded into the second seat body 140, so that the second lens seat 205 and the second bush 145 are respectively forced against inner circumferential surfaces and first outer circumferential surfaces of the first lens barrel 110. In such arrangement, the first lens seat 195 and the second lens seat 205 are constrained from shaking or uttering in a radial direction of the first lens barrel 110 relative to the first lens barrel 110. In addition, when the second lens barrel 120 is disposed around the first lens barrel 110, the first bush 135 is configured to slide within the first slot 121, and the second bush 145 is configured to slide within the second slot 122.

During adjustment of magnification, the second lens barrel 120 is rotated to slide the first bush 135 and the second bush 145 respectively within the first slot 121 and the second slot 122. Since the first sliding portion 155 and the second sliding portion 165 are simultaneously slid within the slot 111, the first lens seat 195 and the second lens seat 205 are moved along the slot 111 relative to the first lens barrel 110. Moreover, since the first slot 121 and the second slot 122 are with different curvatures, the first lens seat 195 and the second lens seat 205 are moved different distances relative to the first lens barrel 110 and along the slot 111, thereby adjusting the magnification of the optical magnification system 100.

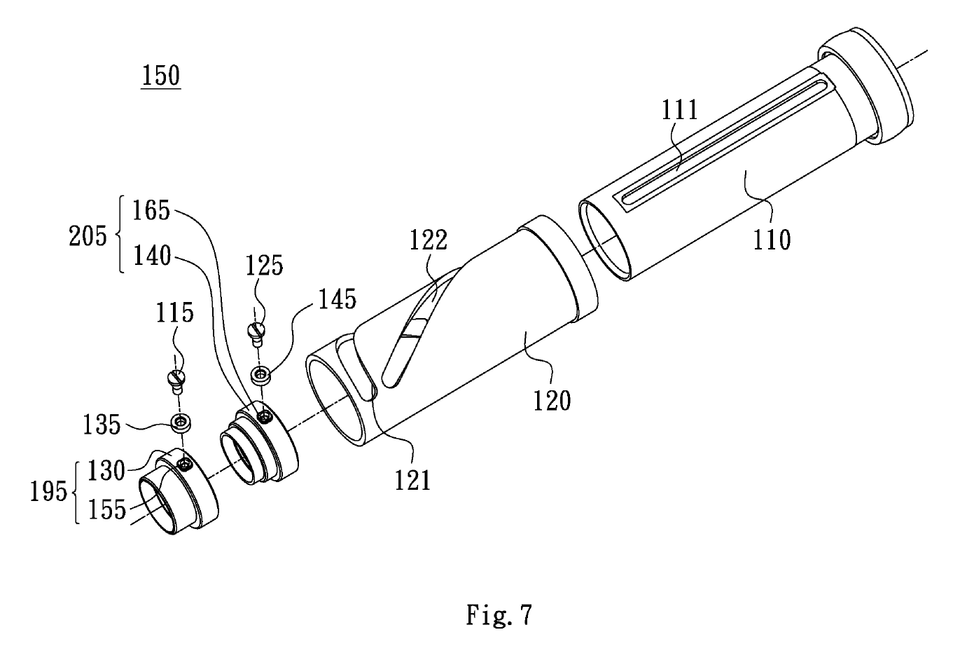

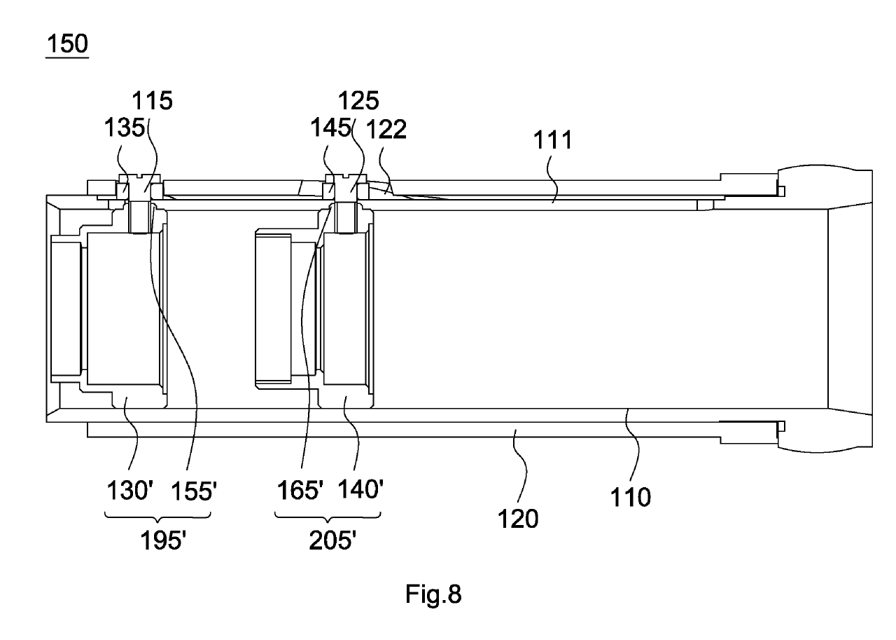

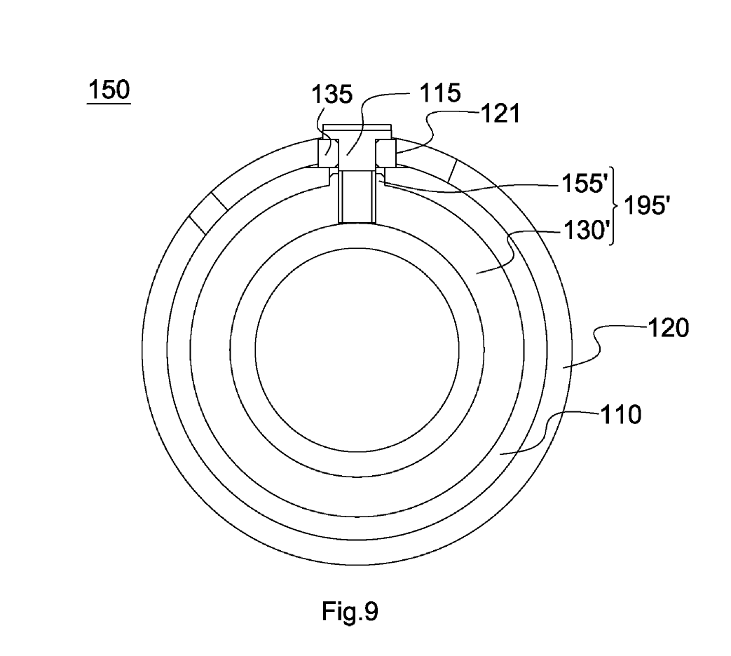

FIGS. 7-9 depict an optical magnification system 150 in accordance with a second embodiment of the invention, in which most elements are identical to those of the optical magnification system 100 of the first embodiment and therefore indicated by the same reference numerals. It is noted that the first sliding portion 155′ is directly disposed on the second outer circumferential surfaces of the first seat body 130′ and extends into the slot 111, and the second sliding portion 165′ is directly disposed on the third outer circumferential surfaces of the second seat body 140′ and extends into the slot 111. In particular, the first sliding portion 155′ and the first seat body 130′ are integrally formed as a continuous-unity piece, and the second sliding portion 165′ and the second seat body 140′ are integrally formed as a continuous-unity piece. That is, the first recessed portion 175 and the second recessed portion 185 of the first embodiment are not provided in the second embodiment. In operation, the first lens seat 195′ is moved along the slot 111 relative to the first lens barrel 110 and constrained from rotating relative to the first lens barrel 110 by way of the first sliding portion 155′, and the second lens seat 205′ is moved along the slot 111 relative to the first lens barrel 110 and constrained from rotating relative to the first lens barrel 110 by way of the second sliding portion 165′. The arrangement of other elements and operation of adjustment of magnification of the second embodiment are similar to those of the first embodiment, and therefore the descriptions thereof are omitted.

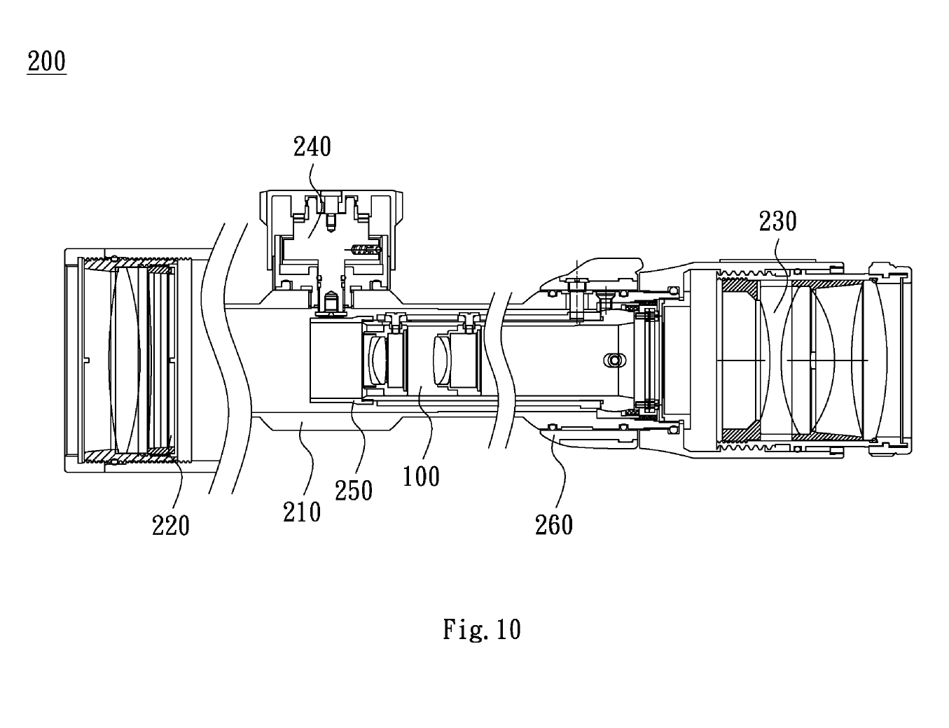

Referring to FIG. 10, a sight 200 includes a main body 210, an objective lens module 220, an eyepiece module 230, an adjusting element 240, a light collecting ring 250, the optical magnification system 100 (or 150) described above and a magnification adjusting ring 260. The objective lens module 220 and the eyepiece module 230 are respectively disposed on a front end and a rear end of the main body 210. The light collecting ring 250 and the optical magnification system 100 are disposed within the main body 210. Specifically, a front end of the optical magnification system 100 is connected to the light collecting ring 250, and a rear end of the optical magnification system 100 is connected to an interior of the main body 210. The magnification ring 260 is rotatably disposed around the main body 210, and is configured to rotate the second lens barrel 120. The adjusting element 240 is mounted on the main body 210, extends into the main body 210 and is placed against the light collecting ring 250, so as to move the optical magnification system 100 upward, downward, leftward or rightward on the base of the rear end of the optical magnification system 100. In operation, a light beam emitted by an object (not shown) in front of the objective lens module 220 passes through the objective lens module 220, the optical magnification system 100 and the eyepiece module 230 in an order, so that the object can be observed by the user. During operation of magnification, the magnification adjusting ring 260 is rotated to rotate the second lens barrel 120, so that the first lens seat 195 and the second lens seat 205 are moved different distances along the slot 111 relative to the first lens barrel 110, thereby adjusting the magnification of the sight 200.

In the optical magnification system of the invention, a sliding portion of a lens seat extends into the slot 111 of the first lens barrel 110, and the lens seat and a bush are respectively forced against the inner circumferential surfaces and the first outer circumferential surfaces of the first lens barrel 110 by a fixing element. By such arrangement, the lens seat is constrained from rotating, shaking or jittering relative to the first lens barrel 110, so that the lens seat can be moved stably in an axial direction of the first lens barrel 110. Therefore, when the optical magnification system is applied to a sight, the problems of uncontrolled rotation, shaking or jittering of the lens seat relative to the inner lens barrel can be eliminated, thereby avoiding the requirements of higher manufacturing accuracy and increased manufacturing cost, and even reducing the product defect rate.

What is claimed is:

1. An optical magnification system, comprising:
a first lens barrel, with a slot formed thereon, comprising inner circumferential surfaces and first outer circumferential surfaces;
a first lens seat comprising a first seat body and a first sliding portion, wherein the first seat body is movably disposed within the first lens barrel, and the first sliding portion is disposed on the first seat body, extends into the slot and is configured to slide within the slot;
a first lens unit disposed within the first lens seat;
a first bush movably disposed on the first lens barrel; and
a first fixing element extending through the first bush and the first sliding portion and fixed to the first seat body;
wherein the first lens seat is configured to move relative to the first lens barrel and along the slot via the first sliding portion;
wherein the first lens seat and the first bush are respectively forced against the inner circumferential surfaces and the first outer circumferential surfaces of the first lens barrel by the first fixing element.

2. The optical magnification system as claimed in claim 1, wherein the first seat body and the first sliding portion are integrally formed as a continuous-unity piece.

3. The optical magnification system as claimed in claim 2, wherein the first seat body comprises a first recessed portion, and the first sliding portion is disposed in the first recessed portion and extends into the slot.

4. The optical magnification system as claimed in claim 3, wherein the first seat body further comprises second outer circumferential surfaces, and the first recessed portion is disposed on the second outer circumferential surfaces.

5. The optical magnification system as claimed in claim 1, wherein the first seat body comprises a first recessed portion, and the first sliding portion is disposed in the first recessed portion and extends into the slot.

6. The optical magnification system as claimed in claim 5, wherein the first seat body further comprises second outer circumferential surfaces, and the first recessed portion is disposed on the second outer circumferential surfaces.

7. The optical magnification system as claimed in claim 1, further comprising a first compression ring configured to fix the first lens unit within the first lens seat.

8. The optical magnification system as claimed in claim 1, further comprising a second lens barrel movably disposed around the first lens barrel, wherein a first slot is formed on the second lens barrel, the first slot is a curved slot, and the first bush is configured to slide within the first slot.

9. The optical magnification system as claimed in claim 1, further comprising:
a second lens seat comprising a second seat body and a second sliding portion, wherein the second seat body is movably disposed within the first lens barrel, and the second sliding portion is disposed on the second seat body, extends into the slot and is configured to slide within the slot;
a second lens unit disposed within the second lens seat;
a second bush movably disposed on the first lens barrel; and
a second fixing element extending through the second bush and the second sliding portion and fixed to the second seat body;
wherein the second lens seat is configured to move relative to the first lens barrel and along the slot via the second sliding portion;
wherein the second lens seat and the second bush are respectively forced against the inner circumferential surfaces and the first outer circumferential surfaces of the first lens barrel by the second fixing element.

10. The optical magnification system as claimed in claim 9, wherein the second seat body comprises a second recessed portion, and the second sliding portion is disposed in the second recessed portion and extends into the slot.

11. The optical magnification system as claimed in claim 10, wherein the second seat body further comprises third outer circumferential surfaces, and the second recessed portion is disposed on the third outer circumferential surfaces.

12. The optical magnification system as claimed in claim 9, wherein the second seat body and the second sliding portion are integrally formed as a continuous-unity piece.

13. The optical magnification system as claimed in claim 12, wherein the second seat body comprises a second recessed portion, and the second sliding portion is disposed in the second recessed portion and extends into the slot.

14. The optical magnification system as claimed in claim 13, wherein the second seat body further comprises third outer circumferential surfaces, and the second recessed portion is disposed on the third outer circumferential surfaces.

15. The optical magnification system as claimed in claim 9, wherein the first seat body and the first sliding portion are integrally formed as a continuous-unity piece.

16. The optical magnification system as claimed in claim 15, wherein the second seat body comprises a second recessed portion, and the second sliding portion is disposed in the second recessed portion and extends into the slot.

17. The optical magnification system as claimed in claim 16, wherein the second seat body further comprises third outer circumferential surfaces, and the second recessed portion is disposed on the third outer circumferential surfaces.

18. The optical magnification system as claimed in claim 9, further comprising a second compression ring configured to fix the second lens unit within the second lens seat.

19. The optical magnification system as claimed in claim 9, further comprising a second lens barrel movably disposed around the first lens barrel, wherein a first slot and a second slot are respectively formed on the second lens barrel, the first slot and the second slot are curved with different curvatures, the first bush is configured to slide within the first slot, and the second bush is configured to slide within the second slot.
